(19) United States
(12) Patent Application Publication
(10) Pub. No.: US 2003/0187770 A1
(43) Pub. Date: Oct. 2, 2003

(54) Economic growth-rate forecasting program and a computer-readable recording media recorded with the same

(76) Inventor: Hideyuki Kamiryo, Saeki-ku (JP)

Correspondence Address: Koda & Androlia, Suite 3850, 2029 Century Park East, Los Angeles, CA, 90067, US

(21) Appl. No.: 10/397,787

(22) Filed: Mar. 26, 2003

(30) Foreign Application Priority Data
Mar. 29, 2002 (JP) 2002-094100

(51) Int. Cl. G06F 17/60

(52) U.S. Cl. 705/35

(57) ABSTRACT

An economic growth-rate forecasting program in which, based upon a prescribed economic mechanism model that can be described by an expanded Cobb-Douglass production function Y=χA·K^{a}·L^{1-a} that expresses production quantity (Y) in terms of variables comprised of technology level quantity (A), capital quantity (K), and employment count (L) and two constants, a coefficient (χ) and capital distribution rate (a), for individual fiscal years; with a use of a computer; and upon input of a plurality of data from at least two consecutive past fiscal years and upon input of a plurality of economic policy variables for forecast fiscal years from the coming fiscal year and beyond; forecasting for production quantities (Y) and capital quantities (K) for the coming fiscal year and beyond and forecasting for economic growth rates comprised of production growth rate (gY) and capital growth rate (gK) are made and outputted.

### BACKGROUND OF THE INVENTION

1. Field of the Invention

The present invention relates to an economic growth-rate forecasting program that conforms to an economic mechanism model that considers bank cost of household savings and distributes net investment not just to capital accumulation but also to technology accumulation and conforms well to practical technology development-type economic mechanisms, and more particularly to an economic growth-rate forecasting program that can be applied to an expanded Cobb-Douglass production function, that employs a computer and outputs forecasts of economic growth rates upon input of economic policy variables based on economic policies for forecast fiscal years, and further to a computer-readable recording medium on which the such a program is recorded.

2. Prior Art

Prior art economic growth-rate forecasting programs conform to an economic mechanism model called the Solow model described by a Cobb-Douglass production function Y=A·K^{a}·L^{1-a} that expresses production quantity (Y) in terms of variables comprised of capital quantity (K) and employment count (L) and two constants, technology level quantity (A), which is a proportional coefficient, and a capital distribution rate (a), and forecasts economic growth rates using a computer.

To find Y(t+1) for a forecast fiscal year t+1, the above-described Solow economic mechanism model in the prior art economic growth-rate forecasting program was first given Y(t) of a past fiscal year, then used the savings rate s as a constant to find savings (S=sY=Sₚ+S_{H}) from corporate savings S_{P} and household savings S_{H}. It treated all the savings as net investment I(t+1) of forecast fiscal year t+1, treated all of the above-described net investment as capital accumulation ΔK, which is the amount of increase in capital quantity (K) in fiscal year t+1, and treated the capital quantity of forecast fiscal year t+1 K(t+1) as K(t)+ΔK. L(t+1) was found from L(t+1)=(1+n)L(t) using employment increase rate n. Using technology level quantity (A), which is a constant calculated from (Y, K, L) of past fiscal year t, and capital distribution rate (a), the Cobb-Douglass production function Y=A·[K(t+1)]^{a}·[L(t+1)]^{1-a} was applied and the economic growth rate found from Y(t+1), K(t+1), and the relative increase rates (gY, gK) for each fiscal year.

The Solow economic mechanism model in the prior art economic growth-rate forecasting program only handled technology level quantity (A) as a constant as a proportional coefficient in the Cobb-Douglass production function, so technological progress did not exist, and since it was treated as a constant, it did not conform to realistic economic mechanisms. Furthermore, all savings were treated as net investment, and the sum of the net investment was treated as capital accumulation ΔK, which meant that the function could not explain savings decreases, which do actually occur. Neither did it include economic policy variables that reflect real economic policies nor conform to economic mechanisms that involve technological development, so the prior art program made it difficult to forecast economic growth rates of forecast fiscal years.

### SUMMARY OF THE INVENTION

In order to solve the above-described problem, the economic growth-rate forecasting program of the present invention is characterized by building an economic mechanism model that defines an expanded Cobb-Douglass production function Y=χA·K^{a}·L^{1-a} expanded as prescribed that conforms to technological development-type economic mechanisms, that has as its production function variables not just capital quantity (K) but also defines a technology level quantity (A) that can be expressed as a monetary amount, that uses economic policy variables (β, θ₁) based on economic policies, that distributes net investment to not just capital accumulation ΔK but also to technology accumulation βA and that obtains (Y, A, K), conforms to the economic mechanism model, employs a computer, and implements the functions of taking as input a plurality of data from at least the past two consecutive fiscal years, also taking as input a plurality of economic policy variables for forecast fiscal years from the coming fiscal year and beyond, and thereby forecasting production quantities (Y) and capital quantities (K) for the coming fiscal year and beyond, also forecasting economic growth rates comprised of production growth rate (gY) and capital growth rate (gK), which are rates of increase for each fiscal year, and then outputting these forecast numbers from the computer.

The above object is accomplished by a unique structure of the present invention for an economic growth-rate forecasting program in which:

based upon a prescribed economic mechanism model that can be described by an expanded Cobb-Douglass production function Y=χA·K^{a}·L^{1-a} that expresses production quantity (Y) in terms of variables comprised of technology level quantity (A), capital quantity (K), and employment count (L) and two constants, a coefficient (χ) and capital distribution rate (a), for individual fiscal years;

with a use of a computer; and

upon input of:

a plurality of data from at least the past two consecutive fiscal years, and

a plurality of economic policy variables for forecast fiscal years from the coming fiscal year and beyond; the program

forecasts production quantities (Y) and capital quantities (K) for the coming fiscal year and beyond,

forecasts economic growth rates comprised of production growth rate (gY) and capital growth rate (gK), which are relative rates of increase for each fiscal year, and

implements a function to output resulting forecast numbers from the computer; wherein

the economic growth rate forecasting program makes the computer function as:

a means for inputting in advance, in addition to production function variables and constants (Y, K, L, a), performance data sets DS(t) and DS(t−1) for at least past two most recent fiscal years t and t−1, which use performance data sets (DS) from past fiscal years comprised of a plurality of data required to calculate at least corporate savings (S_{P}) and household savings (S_{H});

a recording means that records the performance data sets DS(t) and DS(t−1) in advance;

a means for inputting in advance a performance value θ₁ for at least the past fiscal year t in net household saving variable (θ₁), which is one of the economic policy variables, for the economic mechanism model;

a recording means that records in advance the performance data θ₁(t);

a calculation means that calculates calculated performance values (β, A, χ) in advance for at least the past fiscal year t in capital investment distribution variable (β), which is one of the economic policy variables, for the economic mechanism model, as well as the technology level quantity (A) and coefficient (χ);

a recording means that records in advance the calculated performance values (β, A, χ);

a means that outputs β(t) for at least the past fiscal year t of the calculated performance values in advance;

a means for, considering the calculated performance value β(t) and performance value θ₁(t) for at least the past fiscal year t, inputting in advance at least β(t+1) and θ₁(t+1), which are economic policy variables based on economic policies for forecast fiscal years t+1and beyond;

a recording means that records in advance the θ(t+1) and θ₁(t+1);

an operations means that under prescribed initial constant conditions, uses the economic policy variables for forecast fiscal years (β, θ₁), conforms to the economic mechanism model, calculates production function variables (Y, A, K) for at least fiscal year t+1 and beyond, and further calculates forecast values for economic growth rates comprised of gY and gK, which are relative rates of increase for each fiscal year;

a recording means that records the forecast values (Y, A, K) and (gY, gK) for fiscal year t+1 and beyond; and

a means for outputting economic growth rate forecast values comprised of the production quantity and capital quantity forecasts (Y, K) for at least fiscal year t+1 and the production growth rate and capital growth rate (gY, gK).

The above object is further accomplished by computer-readable recording medium of the present invention in which the above-described economic growth-rate forecasting program is recorded in recording medium.

The computer that uses the economic growth-rate forecasting program and the computer-readable recording medium of the present invention includes a central processing unit (CPU) equipped with an operations means and a comparison means, as well as memory, a means for recording prescribed numbers and programs in such a memory, and an input and output means.

### BRIEF DESCRIPTION OF THE DRAWINGS

FIG. 1 is a simple flowchart of the key components of an economic growth-rate forecasting program according to one embodiment of the present invention;

FIG. 2 is a simple economic mechanism model schematic that applies an expanded Cobb-Douglass production function used in an economic growth-rate forecasting program according to one embodiment of the present invention;

FIG. 3 shows input values of a performance data set (DS) for past fiscal years used in input and recording of the DS in step S1 of an economic growth-rate forecasting program according to another embodiment of the present invention;

FIG. 4 is a detailed flowchart of recursible processing of operations and recording processes for production function variables for forecast fiscal years in step S6 of an economic growth-rate forecasting program according to still another embodiment of the present invention;

FIG. 5 shows the results of a forecasting operation simulation for production quantity (Y) and capital quantity (K) calculated using the economic growth-rate forecasting program according to still another embodiment of the present invention, wherein the solid line is the performance values (Y), the black dots are forecast values (Y), the dotted line is performance values (K) and the circles are forecast values (K);

FIG. 6 shows the results of a forecasting operation simulation for production growth rate (gY) and capital growth rate (gK) calculated using the economic growth-rate forecasting program according to still another embodiment of the present invention, wherein the solid line is the performance values (gY), the black dots are forecast values (gY), the dotted line is performance values (gK) and the circles are forecast values (gK);

FIG. 7 shows the results of calculated performance values of past fiscal years for capital investment distribution variable (β) obtained by operations and recording processes on calculated performance values for past fiscal years in step (S3) of the economic growth-rate forecasting program according to still another embodiment of the present invention; and

FIG. 8 shows the linear characteristics that show the relationship γ−θ₂ for the capital investment distribution variable (β) and respective performance values β(i) resulting from the above-described performance value calculations where i=fiscal 1993 and fiscal 1997 according to still another embodiment of the present invention.

### DETAILED DESCRIPTION OF THE INVENTION

In the economic growth-rate forecasting program of the present invention, the production quantity (Y), technology level quantity (A), and capital quantity (K) are characterized by being given and displayed as monetary amounts.

In the economic growth-rate forecasting program of the present invention, the production growth rate gY(i) and capital growth rate gK(i) for fiscal year i are given, respectively, by gY(i)=[Y(i)−Y(i−1)]/Y(i−1) and gK(i)=[K(i)−K(i−1)]/K(i−1) using Y and K for fiscal years i and i−1.

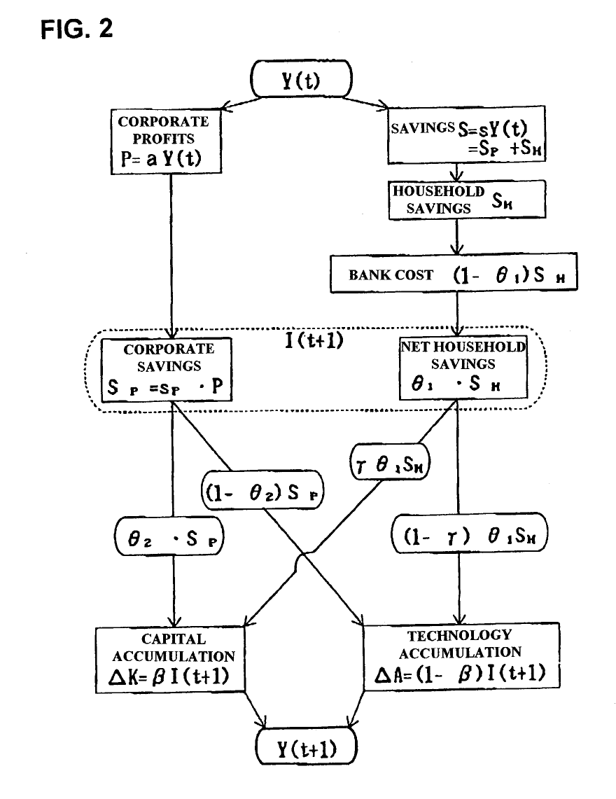

In the economic growth-rate forecasting program of the present invention, the economic mechanism model that can be described by the expanded Cobb-Douglass production function Y=χA·K^{a}·L^{1-a} for each fiscal year, as shown in FIG. 2, is given (Y, A, K, L) for past fiscal year t under conditions in which initial constants (χ, a, s, s_{P}, n) are constant in forecast fiscal year t+1, uses economic policy variables (β, θ₁) based on economic policies for forecast fiscal year t+1, and calculates (Y, A, K, L) for forecast fiscal year t+1; the model first is given Y(t), uses constant a to find corporate profits (P), and then can use constant (s_{P}) to obtain corporate savings (S_{P}) while using savings rate s (which is constant) to find savings (S=sY=S_{P}+S_{H}) and calculate household savings (S_{H}=S−S_{P}), and can also obtain corporate savings S_{P}(t) and household savings S_{H}(t) respectively for past fiscal year t. Next, net household savings variable θ₁(t+1), which is an economic policy variable based on economic policy for forecast fiscal year t+1, is used to obtain net household savings θ₁·S_{H} by subtracting (1−θ₁)·S_{H}, which corresponds to bank costs of forecast fiscal year t+1, from the above-described household savings S_{H}(t). The sum of the above-described corporate savings S_{P} and net household savings θ₁·S_{H} serves as net investment for forecast fiscal year t+1, i.e., I(t+1)=S_{P}+θ₁·S_{H}.

I(t+1)=S_{P}+θ₁·S_{H} (Equation 1)

Next, the above-described corporate savings S_{P} is distributed according to the distribution ratio θ₂:(1−θ₂) to capital accumulation ΔK, which is the amount of increase in capital (K) for forecast fiscal year t+1, and technology accumulation ΔA, which is the amount of increase of technology level quantity amount (A), respectively, using corporate savings investment variable (θ₂), which is an economic policy variable based on economic policy for forecast fiscal year t+1. Meanwhile, the above-described net household savings θ₁·S_{H} is distributed according to the distribution ratio γ:(1−γ) to the capital accumulation ΔK and technology accumulation ΔA, respectively, using household savings investment variable (γ), which is an economic policy variable based on economic policy for forecast fiscal year t+1. The ratio of distribution from the net investment I(t+1) to the capital accumulation ΔK and technology accumulation ΔA is thus β:(1−β), from which the following relational expressions are obtained:

ΔK=β·I(t+1)=θ₂·S_{P}+γθ₁·S_{H} (Equation 2)

ΔA=(1−β)·I(t+1)=(1−θ₂)S_{P}+(1−γ)θ₁·S_{H} (Equation 3)

(A, K, L) for forecast fiscal year t+1 can thus be obtained from the following relational expressions.

A(t+1)=A(t)+ΔA, K(t+1)=K(t)+ΔK, and L(t+1)=(1+n)L(t) (Equation 4)

It is thus possible to obtain Y(t+1) for forecast fiscal year t+1using constant χ. If here Equations 1 and 2 are used to express this in terms of economic policy variables (β, θ₁, θ₂, γ) based on economic policies for forecast fiscal year t+1, the following Equation 5 is obtained:

β=F(θ₁,θ₂,γ)=[θ₂S_{P}+γθ₁S_{H}]/[S_{P}+θ₁S_{H}] (Equation 5)

which expresses them as a function F(θ₁, θ₂, γ) of economic policy variables (θ₁, θ₂, γ), and variable β can be defined by providing the variables (θ₁, θ₂, γ). It is thus possible to calculate Y(t+1) for forecast fiscal year t+1 using only two economic policy variables (β, θ₁) for forecast fiscal year t+1. Conversely, if economic policy variables (β, θ₁) are given, then it is possible to obtain linear characteristics expressed by

γ=β[1+(S_{P}/(θ₁S_{H}))]−θhd 2[S_{P}/(θ₁S_{H})] (Equation 6)

from Equation 5 for the relationship γ−θ₂. The range that the economic policy variables (β, θ₁, θ₂, γ) can take is 0≦θ₁≦1. (β, θ₂, γ) can take any positive or negative value in the range. When the distribution capital arising from any of the above-described (β, θ₂, γ) is negative, it means that the distributed capital from the distribution source is decreasing and flowing out; the amount of the decrease is flowing back to the distribution source.

In the economic growth-rate forecasting program of the present invention, net household savings variable (θ₁) is defined as the ratio of the value obtained by subtracting (1−θ₁)·S_{H}, which corresponds to bank cost, from household savings S_{H}(t) to the above-described household savings S_{H}(t). Thus, as the above-described value θ₁ approaches 1, it shows one of the characteristics of economic policy variables, which is that bank cost becomes smaller.

In the economic growth-rate forecasting program of the present invention, calculation of A in the operations process for obtaining calculated performance values (A, χ) for past fiscal year t takes the logarithms (ln) of both sides in the expanded Cobb-Douglass production function Y=χA·K^{a}·L^{1-a} and then takes the differentials for each of the production function variables (Y, A, K, L) to yield the identity Equation 7 for each fiscal year.

(ΔY/Y)=(ΔA/A)+a(ΔK/K)+(1−a)(ΔL/L) (Equation 7)

Since (ΔY/Y)=[Y(t)−Y(t−1)]/Y(t−1)=gY for fiscal year t, similarly ΔK/K=gK and ΔL/L=n. As is already known from performance data sets DS(t) and DS(t−1):

(ΔA/A)=ΔA/A(t−1)=gY−(a·gK)−(1−a)n

Thus, the following Equation 8 is obtained:

A(t−1)=ΔA/[gY−(a·gK)−(1−a)n] (Equation 8)

Next, ΔA=(1−β)·I(t) from (Equation 3) is substituted into (Equation 8) to obtain monetary amount A(t−1). Thus, since A(t)=ΔA+A(t−1), A(t) displayed as a monetary amount is obtained.

At the same time, it is possible to calculate χ in the above-described operations process by substituting known production function variables (Y, A, K, L) described above for fiscal year t into the expanded production function Y=χA·K^{a}·L^{1-a}.

In the economic growth-rate forecasting program of the present invention, it is possible to make a set of DS variables and constants DS(Y, K, L, a, s, s_{P}) as performance data sets DS(t) and DS(t−1) and obtain these performance data sets using, for example, the “Annual Report on National Accounts of 2001” published by the Economic and Social Research Institute, Cabinet Office, Government of Japan.

The economic growth-rate forecasting program of the present invention and its computer-readable recording medium employs these and uses performance data of a plurality of past fiscal years that have performance data, assumes at least specific economic policy variables (β, θ₁) for forecast fiscal years, can use a repeated operations processing called a recursible process, perform a variety of not only short-term but also medium-term and long-term forecasting operation simulations that forecast production and capital quantities (Y, K) for a desired N years and the production quantity and capital growth rates for them (gY, gK), and has the effect of being able to forecast economic growth rates that have the above-described economic policy variables that reflect future desired economic policies.

The economic growth-rate forecasting program of the present invention and its computer-readable recording medium can forecast economic growth rates for an economic mechanism model described by an expanded production function that takes and displays production quantity (Y), technology level quantity (A), and capital quantity (K) as monetary amounts, so it conforms well to an economic mechanism of a realistic technology development type that distributes net investment not only to capital accumulation but also to technology accumulation, while also having the effect of providing reasonable economic growth rate forecasts that reflect desired economic policies.

In the economic growth-rate forecasting program of the present invention, the relationship (γ−θ₂) between household savings investment variable (γ) and corporate savings investment variable (θ₂) has specific linear characteristics for a specific capital investment distribution variable (β) and net household savings variable (θ₁) in an economic mechanism model that can be described by an expanded Cobb-Douglass production function, so once one of the economic policy variables (γ, θ₂) is defined, the other can be found.

The present invention will be further described below in great detail with reference to the embodiments.

Embodiment 1 of the present invention is first described explained below.

The economic growth-rate forecasting program is a program in which:

based upon a prescribed economic mechanism model that can be described by an expanded Cobb-Douglass production function Y=χA·K^{a}L^{1-a} that expresses production quantity (Y) as national income in terms of variables comprised of technology level quantity (A), capital quantity (K), and employment count (L) and two constants, a coefficient (χ) and capital distribution rate (a), for individual fiscal years;

with a use of a computer; and

upon input of:

a plurality of data from at least the past two consecutive fiscal years, and

a plurality of economic policy variables for forecast fiscal years from the coming fiscal year and beyond; the program

forecasts production quantities (Y) and capital quantities (K) for the coming fiscal year and beyond,

forecasts economic growth rates comprised of production growth rate (gY) and capital growth rate (gK), which are relative rates of increase for each fiscal year, and

implements a function to output the resulting forecast numbers from the computer; wherein

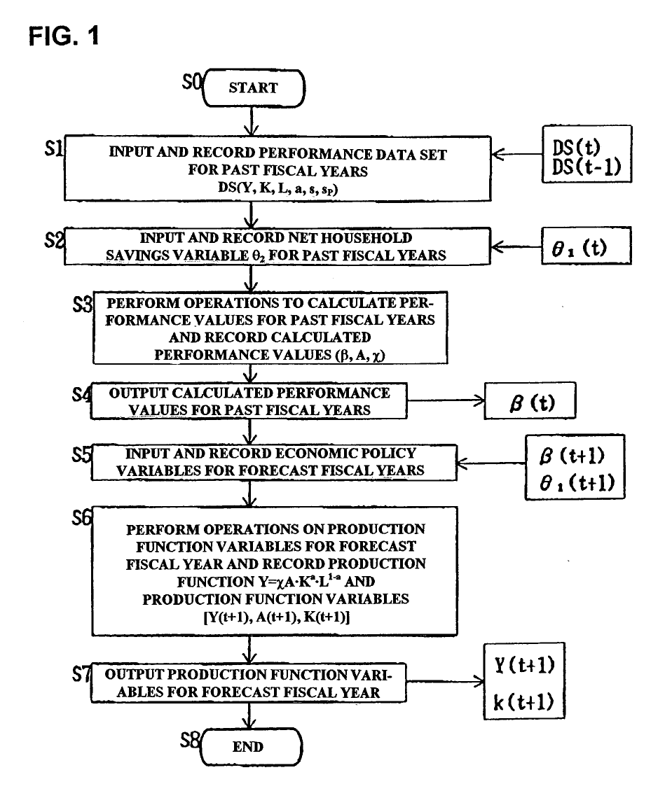

the economic growth rate forecasting program makes, as shown in FIG. 1, the computer function as:

a means for inputting in advance, in addition to the production function variables and constants (Y, K, L, a), performance data sets DS(t) and DS(t−1) for at least the past two most recent fiscal years t and t−1, using performance data sets DS from past fiscal years comprised of a plurality of data required to calculate at least corporate savings (S_{P}) and household savings (S_{H}) in step (S1),

a recording means that records the performance data sets DS(t) and DS(t−1) in advance,

a means for inputting in advance a performance value θ₁ for at least past fiscal year t in the net household saving variable (θ₁), which is one of the economic policy variables, for the economic mechanism model in step (S2),

a recording means that records in advance the performance data θ₁(t),

a calculation means that calculates the calculated performance values (β, A, χ) in advance for at least the past fiscal year t in capital investment distribution variable (β), which is one of the economic policy variables, for the economic mechanism model, as well as the technology level quantity (A) and coefficient (χ) from the expanded Cobb-Douglass production function in step (S3),

a recording means that records in advance the calculated performance values (β, A, χ),

a means that outputs β(t) for at least the past fiscal year t of the calculated performance values in advance in step (S4),

a means for considering the calculated performance value β(t) and performance value θ₁(t) for at least the past fiscal year t and inputting in advance at least β(t+1) and θ₁(t+1), which are economic policy variables based on economic policies for forecast fiscal years t+1 and beyond in step (S5),

a recording means that records in advance the above-described β(t+1) and θ₁(t+1),

an operations means that under conditions in which initial constants (χ, a, s, s_{P}, n), which find the rate of increase in employment count (n(t)=[L(t)−L(t+1)]/L(t−1)) for fiscal year t from the performance data sets DS(t) and DS(t−1) and includes for fiscal year t a savings rate (s=S/Y) that is a ratio of savings (S=S_{P}+S_{H}) to Y, a propensity-to-retain rate (s_{P}=S_{P}/P) that is a ratio of corporate profits (P) to S_{P}, and a capital distribution rate (a=P/Y) that is a ratio of the corporate profits (P) to Y, are constant for fiscal year t+1 and beyond, uses the economic policy variables for forecast fiscal years (β, θ₁), conforms to the economic mechanism model, calculates production function variables (Y, A, K) for at least fiscal year t+1 and beyond, and calculates forecast values for economic growth rates comprised of gY and gK, which are relative rates of increase for each fiscal year in step (S6),

a recording means that records the forecast values (Y, A, K) and (gY, gK) for fiscal year t+1 and beyond, and

a means for outputting economic growth rate forecast values comprised of the production quantity and capital quantity forecasts (Y, K) for at least fiscal year t+1 and the production growth rate and capital growth rate (gY, gK) in step (S7).

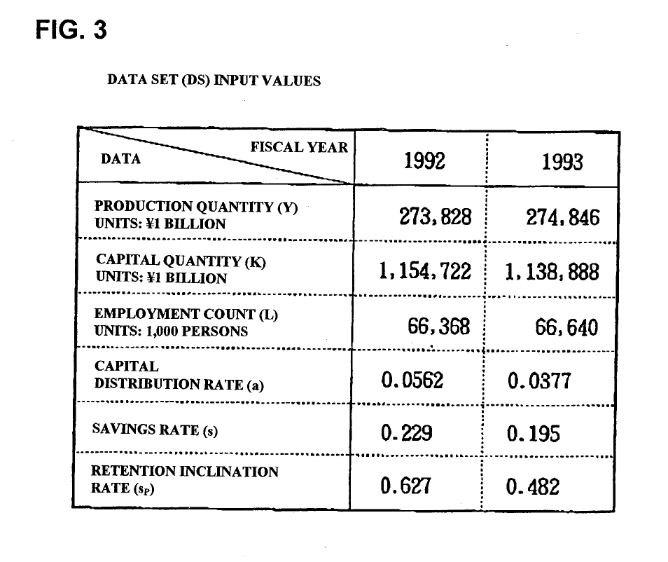

In the economic growth-rate forecasting program of embodiment 1 of the present invention, performance data sets DS(t) and DS(t−1) in step (S1) use fiscal 1993=t as shown in FIG. 3 and adopted the set of DS variables and constants DS(Y, K, L, a, s, S_{P}). Performance data sets for DS(1992) and DS(1993) were obtained from the “Annual Report on National Accounts of 2001” published by the Economic and Social Research Institute, Cabinet Office, Government of Japan. Here, capital quantities (K) are total capital amounts of fixed assets and land respectively for non-financial and financial segments. Production quantities (Y=W+P), which serve as national income, count the total of employment income (W) and corporate profits (P), while the above-described corporate profits (P=D+S_{P}) count the total of dividends (D) and corporate savings (S_{P}). The above-described corporate savings S_{P} count the total of non-financial and financial segments. Savings (S) corrects the total of various savings for non-recurring income/expenditures. Data (a, s, s_{P}) are calculated respectively from (P/Y, S/Y, S_{P}/P).

In the economic growth-rate forecasting program of embodiment 1 of the present invention, as net household savings variable (θ₁) in step (S2) approaches 1, it exhibits the features of an economic policy variable in which bank cost becomes small; although it fluctuates somewhat fiscal year to fiscal year, bank cost has been about 15-20% since fiscal 1992 according to the breakdown of added value by economic activity sector from the “Annual Report on National Accounts of 2001” of the Economic and Social Research Institute, Cabinet Office, Government of Japan, thus a performance value of θ₁ =0.8 is used for Japan.

In the economic growth-rate forecasting program of embodiment 1 of the present invention, operations processing done in step (S3) on performance values calculated for capital investment distribution variable (β), which is an economic policy variable for past fiscal years, first uses performance data sets DS(t) and DS(t−1) input and recorded in step (S1), and then calculates S_{P} and S_{H} of past fiscal year t−1, then uses net household savings variable performance value θ₁=0.8 for past fiscal year t input and recorded in step (S2) and calculates I(t)=S_{P}+θ₁·S_{H} according to Equation 1. It then obtains ΔK=K(t)−K(t−1); since ΔK=β·I(t) from Equation 2, β(t) for past fiscal year t can be found from β=ΔK/I. In embodiment 2, for example, performance data sets DS(1992) and DS(1993) were used, as shown in FIG. 3, ΔK(1993)=15,835 (×¥1 billion) and I(1993)=52,024 (×¥1 billion), and β(1993)=−0.304 was obtained. Since β(1993) is thus <0, the decrease in capital amount |ΔK(1993)|=15,835 (×¥1 billion) and net investment I(1993)=52,024 (×¥1 billion) serve as technology accumulation ΔA(1993).

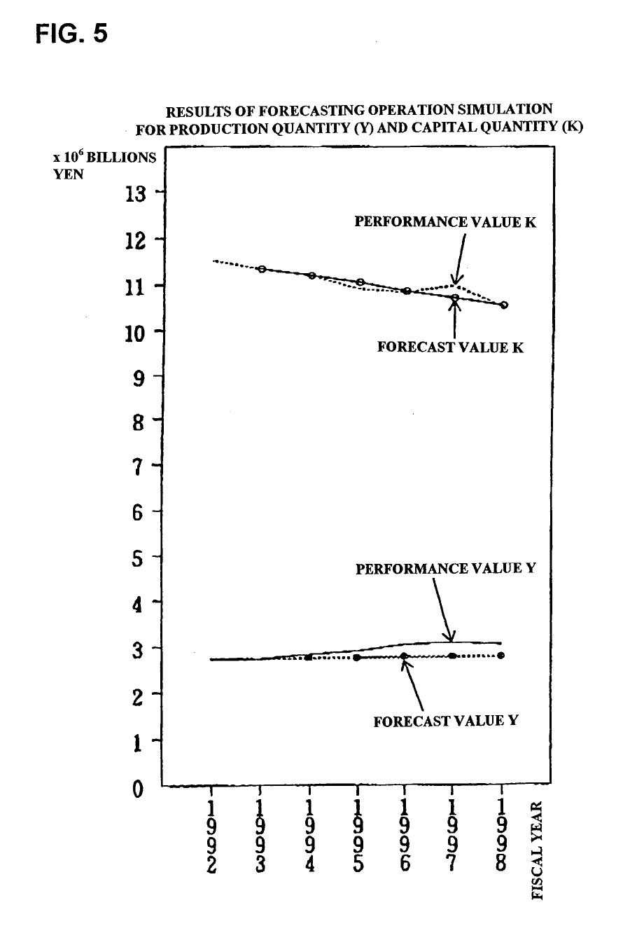

In the economic growth-rate forecasting program of embodiment 1 of the present invention, the calculation of A and χin the operations processing on calculated performance values for the calculated performance values (A, χ) in step (S3), in embodiment 4 as shown in FIG. 5, yields A(1993)=231,670,145 (×¥1 billion) for t fiscal 1993, since ΔA=68,859 (×¥1 billion); using the recorded known values for DS(Y, K, L, a, s, s_{P}) for t=fiscal 1993, χ(1993)=1.52×10⁻⁸ is obtained Units for (Y, A, K) are each ¥1 billion, while units for L are 1000 persons.

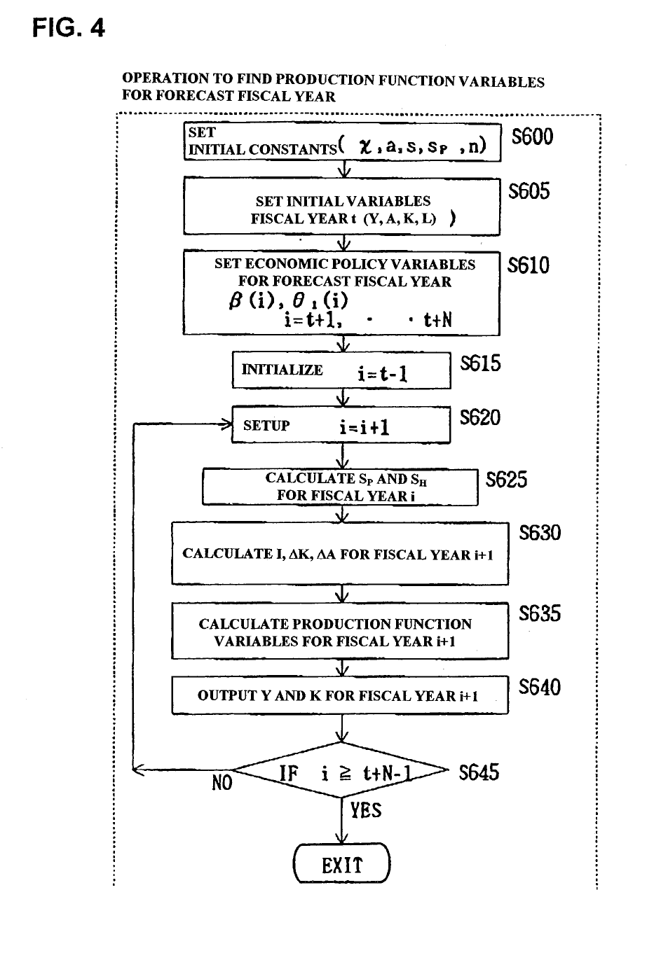

In the economic growth-rate forecasting program of embodiment 3 of the present invention, an operations means that under prescribed initial conditions uses economic policy variables (β, θ₁) based on economic policies for forecast fiscal years, calculates production function variables (Y, A, K) for at least fiscal year t+1 and beyond, and calculates forecast values for economic growth rates comprised of gY and gK for each fiscal year, uses recursible processing as shown in FIG. 4 and can forecast N years from t+1 and beyond in step (S6).

The recursible processing first sets initial constants in step S600, sets initial constants for fiscal year t (χ, a, s, s_{P}, n), and uses the above-described initial constant values as the constants for fiscal year t+1 and beyond; in step S605 it then sets initial variables and sets production function variables (Y, A, K, L) for fiscal year t; in step S610, it then sets the economic policy variables [β(i), θ₁(i)] (i=t+1, t+2, . . . , t+N) input and recorded in advance in each of the N fiscal years to be forecast; in step S615 it then initializes the recursive year variable i=t−1; in step S620 it then updates the above-described variable to i=i+1 to define the start of the above-described recursible processing.

Furthermore, in step S625, it uses the initial variables (a, s, s_{P}) as operations processing for the above-described recursible processing to obtain corporate savings S_{P}(t) and household savings S_{H}(t) for i=fiscal year t. Then, in step S630, it uses net household savings variable θ₁(t+1), calculates net investment for forecast fiscal year t+1 as I(t+1)=S_{P}+θ₁·S_{H}, then also uses capital investment distribution variable β(t+1) and I(t+1) for forecast fiscal year t+1 to calculate ΔK and ΔA for forecast fiscal year t+1 from Equations 2 and 3. Then, in step S635, it uses known fiscal year t production function variables (A, K, L) to obtain A(t+1)=A(t)+ΔA, K(t+1)=K(t)+ΔK, and L(t+1)=(1+n)L(t), applies these variables and initial constant (χ) to expanded production function Y=χA·K^{a}·L^{1-a} to yield Y(t+1), and calculates production function variables (Y, A, K, L) for forecast fiscal year t+1. Next, in step S640, it outputs production function variables (Y, K) for forecast fiscal year t+1 and the gY and gK for them; next, in step S645, it uses a comparison means to return to step S620 if i=t is smaller than t+N−1, performs recursible processing up to step S640 again with the initial condition of i=t+1, then uses the comparison means again in step S645, performing recursible processing until the condition i≧t+N+1 is satisfied, and if it is, then escapes from a series of the above-described recursible processing and ends, and is thereby able to output production function variables (Y, K) for N years starting in t+1and forecast values for gY and gK.

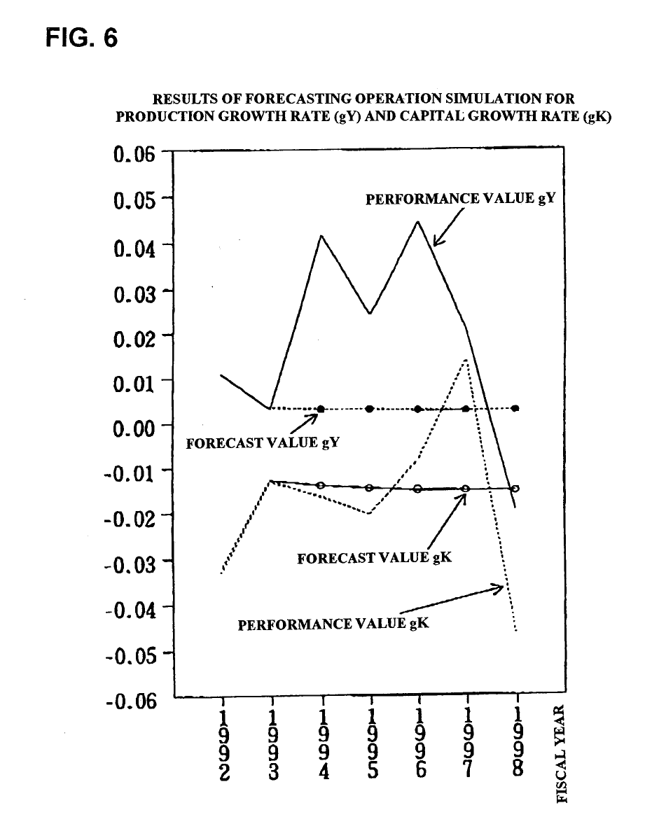

Using as the assumed conditions prescribed economic policy variables [β(i), θ₁(i)] (i=1994, . . . , 1998) for forecast fiscal years with 1992 and 1993 as the past fiscal years that have performance data from the performance data sets DS(1992) and DS(1993) shown in FIG. 3 using the economic growth-rate forecasting program of embodiment 3 of the present invention shown in FIG. 4, FIG. 5 shows the results of a forecasting operating simulation of embodiment 4 forecasting production quantity (Y) and capital quantity (K) for N=5 years from fiscal 1994 to fiscal 1998. FIG. 6 shows the results of a forecasting operation simulation for the associated production growth rate (gY) and capital growth rate (gK) for embodiment 5.

In the above-described forecasting operation simulation, 0.8 is entered for θ₁(1993) for fiscal year 1993 in step S2 , then in step S3 calculated performance values (β, A, χ) for at least fiscal 1993 are pre-calculated. The above-described calculated performance values (β, A, χ) obtained were β(1993)=−0.304, A(1993)=231,670,145 (×¥1 billion), and χ(1993)=1.52×10⁻⁸. From the DS(1992) and DS(1993) shown in FIG. 3, meanwhile, for (a, s, s_{P}, n) the values a(1993)=0.0377, s(1993)=0.195, s_{P}(1993)=0.482, and n(1993)=0.0041 are obtained as the performance values. Thus in step S600, these fiscal 1993 values for (χ, a, s, s_{P}, n) are set as the initial constants.

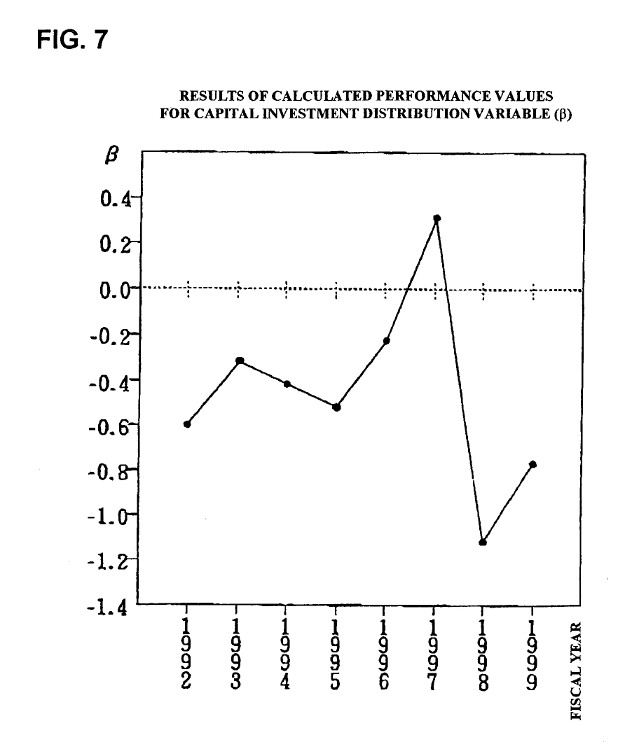

Next, in step S605, we set initial variables for fiscal 1993 (Y, A, K, L) from calculated performance value (A) for fiscal 1993 for step (S3) and DS(1993). Next, in step S610, an assumption setting is made for economic policy variables in which β(i)=β(1993)=−0.304 and θ₁(i)=0.8 in the N=5 year period from fiscal 1994 to fiscal 1998 as the prescribed [β(i), θ₁(i)] (i=1994, . . . , 1998) for the forecast fiscal years. In this manner, under conditions assuming set economic policy variables for the forecast fiscal year, operations processing for production function variables (Y, K) are conducted for the forecast fiscal years N=5 from steps S620 to S645 to obtain the forecast values for production quantity (Y) and capital quantity (K) for each fiscal year and the forecast values for gY and gK. In FIGS. 5 and 6, even though assumption was made for set economic policy variables for β(1993) and θ₁(1993) in the N=5 year period from fiscal 1994 through fiscal 1998, the trend of the forecast values matches the performance values, proving the flexibility of this economic growth-rate forecasting program. Naturally, if a value close to the P performance value shown in FIG. 7 is adopted as the above-described β(i) with the prescribed [β(i), θ₁(i)] (i=1994, . . . , 1998) for the forecast fiscal years, then values for economic growth rate close to the performance values can be forecasted.

FIG. 7 shows the results of calculating performance values for capital investment distribution variable (β), which is an economic policy variable for past fiscal years, using operations processing done on performance values calculated for capital investment distribution in step S3 in the economic growth-rate forecasting program of embodiment 1 of the present invention. Changes in this type in the β performance value match the changes in gK performance values, shown in FIG. 6. This occurs because gK is proportional to capital accumulation ΔK in the economic mechanism model described by the expanded Cobb-Douglass production function. The β for fiscal 1997 of 0.335 shows a big spike toward the positive because lack of demand was dependent on public spending.

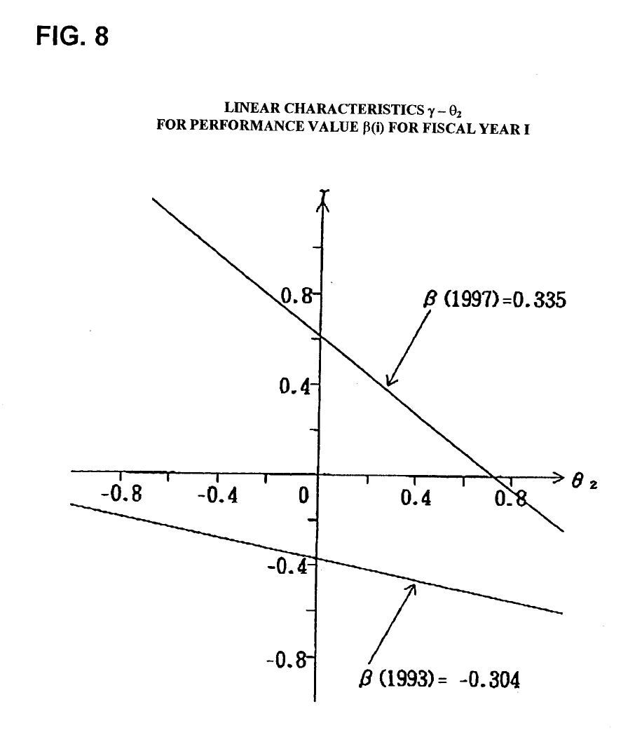

FIG. 8 shows the results when the linear characteristics of γ−θ₂ for performance values of capital investment distribution variable (β), using the results when applying Equation 6 to β(1997)=0.335 and β(1993)=−0.304. The linear characteristics of γ−θ₂ when β(1993)=−0.304 are as shown in FIG. 8, which gives us γ=−0.374−0.229 θ₂. The permitted domain for γ−θ₂ from the linear characteristics is θ₂>−1.64 when γ<0 and θ₂≦1.64 when γ≧0; if either the value or estimated domain of either economic policy variable (γ, θ₂) can be ascertained, the other can be found. The linear characteristics of γ−θ₂ when β(1997)=0.335, meanwhile, are as shown in FIG. 8, which gives us γ=0.621−0.854θ₂. The permitted domain for γ−θ₂ from the linear characteristics is θ₂≦0.727 when γ≧0 and θ₂>0.727 when γ<0; again, if either the value or estimated domain of either economic policy variable (γ, θ₂) can be ascertained, the other can be found.

The present invention is implemented in the manner described above and has the effects described below.

The economic growth-rate forecasting program and its computer-readable recording medium of the present invention can forecast economic growth rates for an economic mechanism model described by an expansion production function that takes and displays production quantity (Y), technology level quantity (A), and capital quantity (K) as monetary amounts, so it conforms well to practical technology development-type economic mechanisms that distribute net investment not just to capital accumulation but also to technology accumulation, and also provides reasonable forecasts of economic growth rates that reflect desired economic policies.

The economic growth-rate forecasting program of the present invention and its computer-readable recording medium employs these and uses performance data of a plurality of past fiscal years that have performance data, assumes at least specific economic policy variables (β, θ₁) for forecast fiscal years, can use a repeated operations processing called a recursible process, perform a variety of not only short-term but also medium-term and long-term forecasting operation simulations that forecast production and capital quantities (Y, K) for a desired N years and the production and capital growth rates for them (gY, gK), and has the effect of being able to forecast economic growth rates that have the economic policy variables that reflect future desired economic policies.

In the economic growth-rate forecasting program of the present invention, the relationship (γ−θ₂) between household savings investment variable (γ) and corporate savings investment variable (θ₂) has specific linear characteristics for a specific capital investment distribution variable (β) and net household savings variable (θ₁) in an economic mechanism model that can be described by an expanded Cobb-Douglass production function, so once one of the economic policy variables (γ, θ₂) is defined, the other can be found.

1. An economic growth-rate forecasting program wherein:
based upon a prescribed economic mechanism model that can be described by an expanded Cobb-Douglass production function Y=χA·K^{a}·L^{1-a} that expresses production quantity (Y) in terms of variables comprised of technology level quantity (A), capital quantity (K), and employment count (L) and two constants, a coefficient (χ) and capital distribution rate (a), for individual fiscal years;
with a use of a computer; and
upon input of:
a plurality of data from at least the past two consecutive fiscal years, and
a plurality of economic policy variables for forecast fiscal years from the coming fiscal year and beyond;
said program
forecasts production quantities (Y) and capital quantities (K) for the coming fiscal year and beyond,
forecasts economic growth rates comprised of production growth rate (gY) and capital growth rate (gK), which are relative rates of increase for each fiscal year, and
implements a function to output resulting forecast numbers from said computer; wherein
said economic growth rate forecasting program makes said computer function as:
a means for inputting in advance, in addition to production function variables and constants (Y, K, L, a), performance data sets DS(t) and DS(t−1) for at least past two most recent fiscal years t and t−1, which use performance data sets (DS) from past fiscal years comprised of a plurality of data required to calculate at least corporate savings (S_{P}) and household savings (S_{H});
a recording means that records said performance data sets DS(t) and DS(t−1) in advance;
a means for inputting in advance a performance value θ₁ for at least the past fiscal year t in net household saving variable (θ₁), which is one of the economic policy variables, for said economic mechanism model;
a recording means that records in advance said performance data θ₁(t);
a calculation means that calculates calculated performance values (β, A, χ) in advance for at least the past fiscal year t in capital investment distribution variable (β), which is one of the economic policy variables, for said economic mechanism model, as well as said technology level quantity (A) and coefficient (χ);
a recording means that records in advance said calculated performance values (β, A, χ);
a means that outputs β(t) for at least the past fiscal year t of said calculated performance values in advance;
a means for, considering said calculated performance value β(t) and performance value θ₁(t) for at least the past fiscal year t, inputting in advance at least β(t+1) and θ₁(t+1), which are economic policy variables based on economic policies for forecast fiscal years t+1 and beyond;
a recording means that records in advance said β(t+1) and θ₁(t+1);
an operations means that under prescribed initial constant conditions, uses said economic policy variables for forecast fiscal years (β, θ₁), conforms to said economic mechanism model, calculates production function variables (Y, A, K) for at least fiscal year t+1 and beyond, and further calculates forecast values for economic growth rates comprised of gY and gK, which are relative rates of increase for each fiscal year;
a recording means that records said forecast values (Y, A, K) and (gY, gK) for fiscal year t+1 and beyond; and
a means for outputting economic growth rate forecast values comprised of said production quantity and capital quantity forecasts (Y, K) for at least fiscal year t+1 and said production growth rate and capital growth rate (gY, gK).

2. A computer-readable recording medium recorded with an economic growth-rate forecasting program wherein:
based upon a prescribed economic mechanism model that can be described by an expanded Cobb-Douglass production function Y=χA·K^{a}·L^{1-a} that expresses production quantity (Y) in terms of variables comprised of technology level quantity (A), capital quantity (K), and employment count (L) and two constants, a coefficient (χ) and capital distribution rate (a), for individual fiscal years;
with a use of a computer; and
upon input of:
a plurality of data from at least the past two consecutive fiscal years, and
a plurality of economic policy variables for forecast fiscal years from the coming fiscal year and beyond;
said program
forecasts production quantities (Y) and capital quantities (K) for the coming fiscal year and beyond,
forecasts economic growth rates comprised of production growth rate (gY) and capital growth rate (gK), which are relative rates of increase for each fiscal year, and
implements a function to output resulting forecast numbers from said computer; and wherein
in said computer-readable recording medium, said economic growth rate forecasting program makes said computer function as:
a means for inputting in advance, in addition to production function variables and constants (Y, K, L, a), performance data sets DS(t) and DS(t−1) for at least past two most recent fiscal years t and t−1, which use performance data sets (DS) from past fiscal years comprised of a plurality of data required to calculate at least corporate savings (S_{P}) and household savings (S_{H});
a recording means that records said performance data sets DS(t) and DS(t−1) in advance;
a means for inputting in advance a performance value θ₁ for at least the past fiscal year t in net household saving variable (θ₁), which is one of the economic policy variables, for said economic mechanism model;
a recording means that records in advance said performance data θ₁(t);
a calculation means that calculates calculated performance values (β, A, χ) in advance for at least the past fiscal year t in capital investment distribution variable (β), which is one of the economic policy variables, for said economic mechanism model, as well as said technology level quantity (A) and coefficient (χ);
a recording means that records in advance said calculated performance values (β, A, χ);
a means that outputs β(t) for at least the past fiscal year t of said calculated performance values in advance;
a means for, considering said calculated performance value β(t) and performance value θ₁(t) for at least the past fiscal year t, inputting in advance at least β(t+1) and θ₁(t+1), which are economic policy variables based on economic policies for forecast fiscal years t+1 and beyond;
a recording means that records in advance said β(t+1) and θ₁(t+1);
an operations means that under prescribed initial constant conditions, uses said economic policy variables for forecast fiscal years (β, θ₁), conforms to said economic mechanism model, calculates production function variables (Y, A, K) for at least fiscal year t+1 and beyond, and further calculates forecast values for economic growth rates comprised of gY and gK, which are relative rates of increase for each fiscal year;
a recording means that records said forecast values (Y, A, K) and (gY, gK) for fiscal year t+1 and beyond; and
a means for outputting economic growth rate forecast values comprised of said production quantity and capital quantity forecasts (Y, K) for at least fiscal year t+1 and said production growth rate and capital growth rate (gY, gK).
